(19) United States
(12) Patent Application Publication
(10) Pub. No.: US 2008/0268901 A1
(43) Pub. Date: Oct. 30, 2008

(54) Slider twister phone

(76) Inventor: Ivan Miramontes, Fontana, CA (US)

Correspondence Address: SETO PATENTS, 406 RIVERLAND DR., SALEM, VA, 24153, US

(21) Appl. No.: 12/006,664

(22) Filed: Jan. 4, 2008

Related U.S. Application Data
(60) Provisional application No. 60/904,813, filed on Mar. 5, 2007.

(51) Int. Cl. H04M 1/00; H04B 1/38

(52) U.S. Cl. 455/556.1; 455/566; 348/14.02

(57) ABSTRACT

A personal entertainment and communication device that provides cell phone, MP3, and video game capabilities. The front of the device includes two touch screens. The bottom touch screen displays a telephone keypad while in the telephone mode, and music player control buttons while in the MP3 mode. The bottom half of the device can be twisted around 180 degrees to expose a set of video game control buttons. An extension can slide out from behind the top half of the device to expose a second set of the video game control buttons. The top touch screen displays telephone information in the telephone mode, and video animation while in the video game mode. In an alternative embodiment, the bottom half of the device can be twisted and the top half extension slid open to expose a full qwerty keyboard.

The present invention was originally disclosed in U.S. provisional patent application No. 60/878,216 filed on Jan. 3, 2007 and in U.S. provisional patent application No. 60/904,813 filed on Mar. 5, 2007 and priority is claimed to the provisional applications.

### BACKGROUND OF THE INVENTION

The present invention relates generally to the field of smart cellular telephones and more specifically to a device that uses virtual buttons to operate as a telephone and a music player, and also provides real buttons to operate as a video game player and a texting device with full qwerty keyboard.

The basic concept of transforming a human voice into an undulating current is still in use today in some analog wire line systems. Advances in modern technology have increased the capabilities of the modern telephones wherein both voice and data can be carried over a telephone line in a digital form. Today, a physical telephone line today is not even a requirement as radio waves can now be used to carry voice and data. Such radio waves are used in cordless telephones found in many of today's households and also make cellular telephone systems possible.

A basic telephone set contains a transmitter that transfers the caller's voice, a receiver that amplifies sound from an incoming call, a rotary or push-button dial and, a ringer or alerter. A small assembly of electrical parts, called the anti-sidetone network that keeps the caller's voice from sounding too loud through the receiver is also included. A speakerphone has a microphone and speaker in the base in addition to the transmitter and receiver in the handset. Speakerphones allow callers' hands to be free, and allow more than two people to listen and speak during a call. In a cordless phone, the handset cord is replaced by a radio link between the handset and base, but a line cord is still used between the base and the telephone line. This allows a caller to move about in a limited area while on the telephone. A cellular phone has miniaturized components that make it possible to combine the base and handset into one handheld unit. No line or handset cord is needed with a cellular phone thereby providing maximum mobility. Touch screens are recent improvement that allows the user to input data simply by touching the screen in the area of the desired object. Small capacitors in the screen register the touch and the object is “selected”.

A cellular telephone is designed to give the user maximum freedom of movement while using a telephone. A cellular telephone uses radio signals to communicate between the “cell phone” and a base station, via an antenna. The served area is divided into cells something like a honeycomb, and an antenna is placed within each cell and connected by telephone lines to one exchange devoted to cellular-telephone calls. This exchange connects cellular telephones to one another and transfers the call to a regular exchange, public switched telephone network, if the call is between a cellular telephone and a non-cellular telephone. The special cellular exchange, through computer control, selects the antenna closest to the telephone when service is requested. As the telephone roams, the exchange automatically determines when to change the serving cell based on the power of the radio signal received simultaneously at adjacent sites. This change occurs without interrupting conversation.

For long-distance calls, the telephone signal is digitized, or converted to a series of pulses that encodes the information. When an analog electrical signal is digitized, samples of the signal's strength are taken at regular intervals, usually about 8000 samples per second. Each sample is converted into a binary form, a number made up of a series of 1s and 0s. This number is easily and swiftly passed through the switching system. Digital transmission systems are much less subject to interfering noise than are analog systems. The digitized signal can then be passed through a digital-to-analog converter (DAC) at a point close to the receiving party, and converted to a form that the ear cannot distinguish from the original signal. There are several ways a digital or analog signal may be transmitted, including coaxial and fiber-optic cables and microwave and longwave radio signals sent along the ground or bounced off satellites in orbit around the earth. Most communications satellites are in geosynchronous orbit—that is, they orbit the earth once a day over the equator, so the satellite is always above the same place on the earth's surface. That way, only a single satellite is needed for continuous service between two points on the surface, provided both points can be seen from the satellite.

Computer-controlled exchange switches make it possible to offer a variety of extra services to both the residential and the business customer. Some services to which users may subscribe at extra cost are call waiting, in which a second incoming call, instead of receiving a busy signal, hears normal ringing while the subscriber hears a beep superimposed on the conversation in progress; and three-way calling, in which a second outgoing call may be placed while one is already in progress so that three subscribers can then talk to each other. Other services available to users are: caller ID, in which the calling party's number is displayed to the receiver on special equipment before the call is answered; and repeat dialing, in which a called number, if busy, will be automatically redialed for a certain amount of time. Of course users have the ability to block their name and phone from being displayed on a caller ID display. Another popular service is voice mail. While traditional answering machines cannot take a message if a caller is already on the line, voice mail creates a second virtual line. While a caller is talking to one party, a second incoming call is greeted with a message asking the second party to leave a message. The user will then be notified of the waiting message.

Unified messaging and the arrival of mobile Internet services means Short Message Service (SMS), a mobile messaging service, will soon become the primary alert mechanism for users to check and pick up their e-mail, fax or voice messages. The rapidly growing availability of WAP (Wireless Application Protocol) has enabled handsets to enhance the customer experience of reading and sending more messages. The arrival of the GSM (Global System for Mobile communications) family's next phase of evolution in the form of GPRS (General Packet Radio Services) will ensure faster speeds and boost the variety of mobile services available significantly. Mobile banking, M-Commerce, and customer service applications are also bolstering SMS traffic. The arrival of more advanced data services will yet again increase demand. During the First (1G) and Second (2G) Generations of mobile communications different regions of the world pursued different mobile phone standards. Europe pursued NMT and TACS for analog and GSM for digital. North America pursued AMPS for analog and a mix of TDMA, CDMA and GSM for digital. The Third Generation (3G), based on CDMA technology, will bring these incompatible standards together and allow convergence toward a common standard for mobile multimedia.

### SUMMARY OF THE INVENTION

A personal electronic device that can be used as a cellular telephone, a video and music player, as a video game player with real video game control buttons, or as a texting device with full qwerty keyboard. The device comprises a first touch screen that displays telephone data when the device is in the telephone mode, and music and video information when the device is in the digital music and video mode. The first touch screen can also display video game animation when the device is in the video game player mode, and texting information while in the keyboard mode. A second touch screen is advantageously used to display a telephone keypad when the device is in the telephone mode, and music player control buttons when the device is in the digital music and video mode. The first touch screen is preferably located in the top half of the device, and the second touch screen located in the bottom half of the device, with both screens on the front of the device.

The bottom half of the device further preferably comprises a back, and a first set of gaming control buttons are provided on the back of the bottom half of the device. The bottom half the device is also rotate-able, relative to the top half of the device, so that when the bottom half is rotated 180 degrees the device enters a second position, wherein the gaming control buttons are presented to the user. The device is programmed to automatically enter the game player mode upon when the bottom half is twisted. The top half of the device further comprises a back that is slide-able, relative to the front of the device. The back of the top half slides upward past the top of the device, so that an extension of the device is provided above the first touch screen. The back of the top half forms an extension to the device and exposes a second set of gaming control buttons for use by the user. The extension of the device is flush and level with the first touch screen locked in place.

The preferred embodiment is able to provide voice and text communications, and access to the Internet, while in the telephone mode, and further comprises wireless data transmission applications that are compatible with SIM Application Toolkit, Wireless Application Protocol (WAP), Bluetooth, Wi-Fi/Wi-Max, a TV tuner, and a digital camera.

The telephone data displayed by the first touch screen includes outgoing call information, incoming call information, address book information, remaining battery power, antenna signal strength, texting information and Internet browser information. The telephone keypad data displayed by the second touch screen includes numbers, letters and symbols.

It is an object of the present invention to provide a multipurpose device that looks like a cellular telephone when being used as a telephone, and looks like a digital music player when being used as a music player.

It is further object of the present invention to provide a unique, two touch screen design for a personal electronic device.

It is another object of the present invention to provide a smart phone with two touch screens that can change orientation to provide video game player with two sets of real control buttons.

It is yet another object of the present invention to provide a smart phone with two touch screens that can change orientation to present a texting device with a full qwerty keyboard with real buttons to the user.

### BRIEF DESCRIPTION OF THE DRAWINGS

The invention of the present application will now be described in more detail with reference to the accompanying drawings, given only by way of example, in which:

FIG. 1(a) is a frontal view of the preferred embodiment in the telephone mode;

FIG. 1(b) is a frontal view of the preferred embodiment in the digital music player mode;

FIG. 2(a) is a frontal view of the preferred embodiment before sliding and twisting into the game player position;

FIG. 2(b) shows the preferred embodiment after sliding and twisting into the game player position;

FIG. 3(a) is a frontal view of an alternative embodiment before sliding and twisting into a texting device with full qwerty keyboard;

FIG. 3(b) shows the alternative embodiment after sliding and twisting into the texting device with full qwerty keyboard;

FIG. 4 is a flow chart showing exemplary steps for displaying information on the two touch screens;

FIG. 5 is a block diagram showing exemplary hardware in the preferred embodiment;

FIG. 6(a) shows an alternate embodiment of the present invention;

FIG. 6(b) shows the alternate embodiment with full qwerty keyboard on the second touch screen;

FIG. 6(c) shows the alternate embodiment with the first half of a qwerty keyboard on the second touch screen; and,

FIG. 6(d) shows the alternate embodiment with the second half of a qwerty keyboard on the second touch screen.

### DETAILED DESCRIPTION OF THE INVENTION

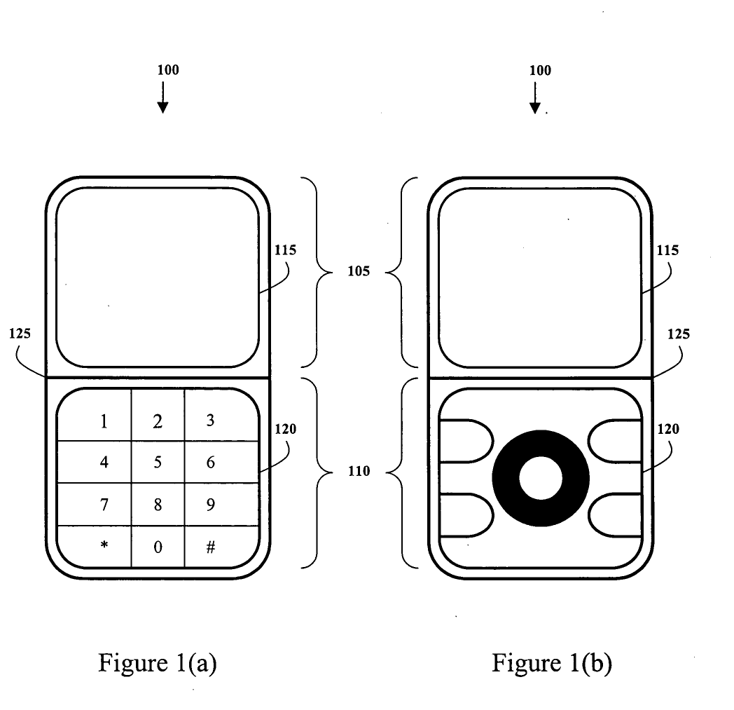

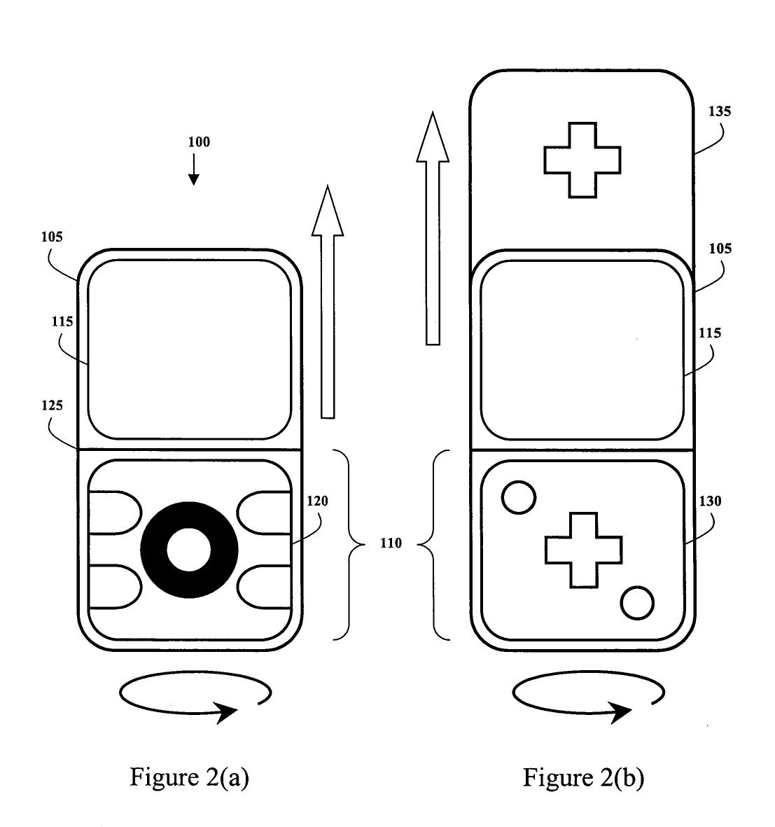

FIG. 1(a) shows a frontal view of the preferred embodiment 100, of the present Slider Twister Phone, which includes a top half 105 and a bottom half 110. The front of the device 100 includes a first touch screen 115 and a second touch screen 120. Providing two touch screens on the device 100 greatly increases the functionality of the device as the screens can be used to display video, pictures, text and any number of virtual buttons for use by the owner. The bottom half of a traditional cell phone provides real buttons that are hardwired to a particular number, so that the user can dial a telephone number. The bottom half of the present device 100 is able to display virtual buttons representing a traditional telephone keypad, on the second touch screen 120, when the device is needed as a telephone, and can also be used to display other virtual buttons, such as control buttons for a digital music player, for example; shown in FIG. 1(b). The two halves of the device 100 are partially separated from each other by a seam 125, which allows further capabilities, discussed below in conjunction with FIG. 2(b).

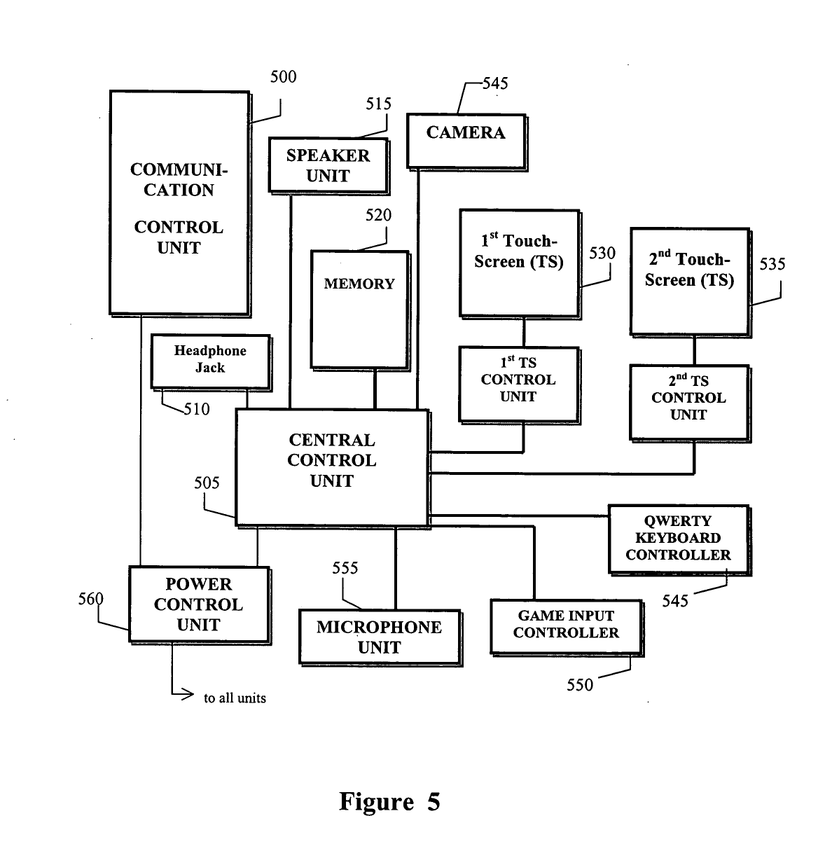

FIG. 1(b) shows the versatility of using a second touch screen 120 in the Slider Twister Phone, which no longer displays a telephone keypad. FIG. 1(b) shows the device 100 in the digital music player, or MP3, mode. The second touch screen 120 has gone from displaying numbers, so that a telephone call could be made, to displaying control buttons, similar to an MP3 player, so the user can select and play music on the present device 100. The song files, the music player software, and the slider-twister software that allows the device to switch between, and operate in, different modes, are stored in the device's memory; discussed further below in conjunction with FIG. 5.

FIG. 2(a) is a frontal view of the preferred embodiment 100 before sliding and twisting into the game player position. The top half 105 of the device includes a backside that is able to slide relative to the first touch screen 115. A track and rotating “L” shaped joint enable the motion of the backside. The bottom half 110 of the device also rotates relative to the top half 105 of the device 100. A ball joint with detent and indent are used to enable the rotation and snapping into position after 180 degrees of rotation.

FIG. 2(b) shows the preferred embodiment 100 after sliding and twisting into the game player position. The bottom half 110 of the device 100 has been twisted 180 degrees so that a panel 130 containing a set of video game control buttons is exposed and made available for pressing by the user. The panel 130 preferably contains real, not virtual, buttons for pressing. The backside of the top half 105 of the device has also been exposed to form an extension 135 of the device. The extension 135 can be used to provide any number of real buttons for pressing by the user. In FIG. 2(b) a second set of video game control buttons are provided for the user, with each leg of the “X” providing a different command. When the extension 135 is fully extended and locked into position, the face of the extension is flush with the face of the first touch screen 115.

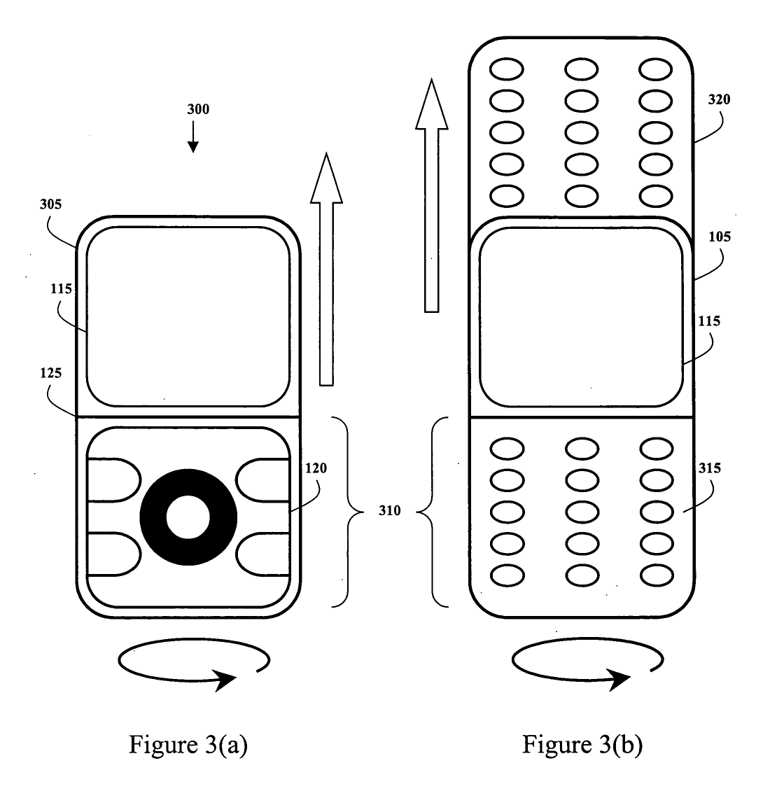

FIG. 3(a) is a frontal view of an alternative embodiment 300 of the present device before sliding and twisting into a second position, wherein a full qwerty keyboard is exposed. In the first position, shown in FIG. 3(a), the device 300 appears similar to the preferred embodiment, with two touch screens 115 & 120 that together allow the device to serve multiple purposes, including a telephone and a digital music player. The alternative embodiment 300 also has a top half 305 with a sliding backside, and a rotating bottom half 310 with real buttons on its backside.

FIG. 3(b) shows the alternative embodiment 300 after sliding and twisting into a texting device with full qwerty keyboard. The bottom half 310 of the device is twisted 180 degrees, and the half of a full qwerty keyboard 315 is exposed. The buttons on the keyboard 315 are preferably real, not virtual, buttons, so the user is able to texturally feel each button with his thumb or fingertips. The extension in this embodiment slides out from behind the first touch screen 115 to expose the other half of the full qwerty keyboard 320. Again, real buttons are provided on the right half of the keyboard 320 so the user can feel each button. As with the preferred embodiment, the face of the extension is flush with the first touch screen 115, when locked into position. After sliding and twisting, the device is designed to be laid on its side so the user can access one half of the keyboard with one of her thumbs, and access to the other half of the keyboard with the other thumb.

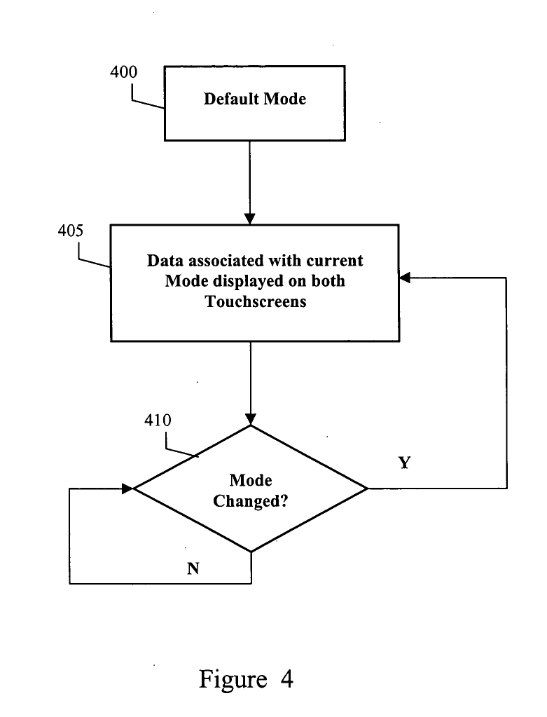

FIG. 4 is a flow chart showing exemplary steps for displaying information on the two touch screens. The preferred slider twister software package allows the device to operate in at least four different modes: cellular telephone; digital music and video player; video game player; and, full qwerty keyboard. The cellular telephone mode is the default mode and the mode that is initially entered upon power up. In the cellular telephone mode, the device operates as a regular cellular telephone with the traditional list of cell phone features, including voice mail, phonebooks, call logs, the ability to send text messages, and access the Internet. The bottom touch screen initially displays a traditional telephone keypad and the top touch screen display other telephone information, including at least one menu that allows the user select other screens and other modes. The slider twister software preferably includes Short Messaging Service (SMS), Multi-media Messaging Service (MMS), Instant Messaging (IM) and Electronic Mail (e-mail). In the digital music and video player mode the front of the device tries to look like a traditional music digital music player. The bottom touch screen displays virtual traditional digital music player control buttons, and the top touch screen displays a video, artist and song information and/or at least one menu that allows the user to select other screens and change modes. In the video game player mode, which is entered into automatically when the device has been slid and/or twisted into a second position, the user is given real buttons on both sides of the first touch screen with which to play any number of video games. The first touch screen is used to display gaming animation, and the second touch screen is made inactive. In the full qwerty keyboard mode, the user is presented with both halves of a full qwerty keyboard for texting and message construction. The first touch screen displays texting information and at least one menu. The second touch screen is made inactive, until the bottom half of the device is twisted and the screen again faces the user, at which time the screen returns to the default mode. The device has a software module associated with each mode, and runs the software module associated with the current mode. A supervisory program constantly monitors the current mode, which can be changed by a tap on one of the touch screens or by movement of one of the halves of the device. In step 400, after initial power up, the device enters the default mode. The default mode is initially the cellular telephone mode. However, the default mode can be changed by the user. In step 405, data associated with the current mode is sent to each touch screen for display. In step 410, the program checks to see if any signal has been sent, or any movement made, that indicates a mode change. If no change has been made, the program loops at step 410 until a mode change is detected. If a signal has been received indicating a mode change, then the appropriate software module is activated and appropriate data is sent to the two touch screens.

FIG. 5 is a block diagram showing exemplary hardware in the preferred embodiment. The communication control unit 500 handles all cellular communications for the device. The central control unit 505 handles all other capabilities for the device, including music player, game player and texting applications. Software modules, files, data and instructions, are stored in the memory 520. The speaker 515 and the headphone jack 510 are provided for use in the telephone mode, the music player, and the game player modes. The camera 525 complements the traditional list of cell phone features. Display controllers are provided for both the 1^{st} and 2^{nd} touch screens 530 & 535 for sending, receiving and processing display information. Controller 545 handles signals from the full qwerty keyboard, and controller 550 handles signals from the video game control buttons. A traditional speaker 555 is provided, and the power control unit 560 connects to all hardware units; connections are not show for clarity purpose. The preferred hardware and software supports Short Messaging Service (SMS), Multi-media Messaging Service (MMS), Instant Messaging (IM), Electronic Mail (e-mail), Bluetooth, Wi-Fi/Wi-Max, memory cards or sticks, and viewing of television.

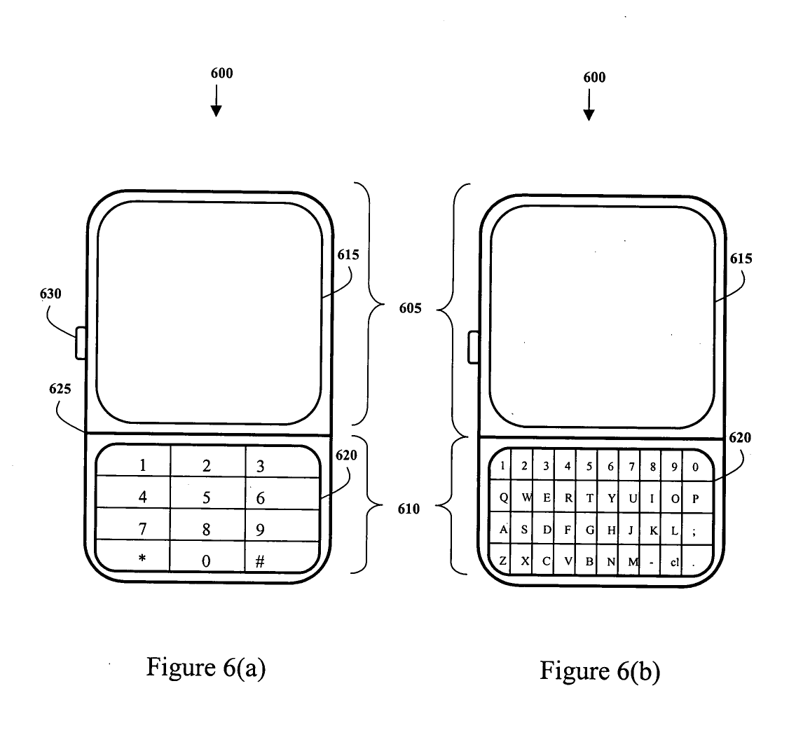

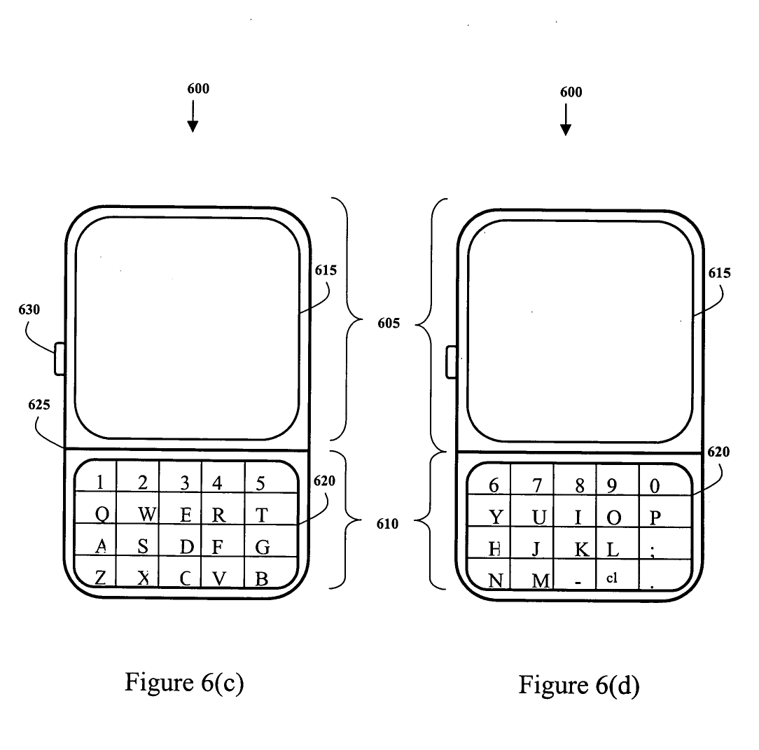

FIG. 6(a) shows an alternate embodiment 600 of the present Slider Twister Phone. This embodiment 600 includes an upper portion 605 with a first touch screen 615 on the front, and a bottom portion 610 with a second touch screen 620 on the front. Just as with the preferred embodiment, the upper portion 605 and lower portion 610 are separated by a seam 625, and the two portions are able to rotate relative to one another. In FIG. 6(a) the screens are in the default (cellular telephone) mode, and a virtual telephone keypad is displayed in the bottom half 610 of the device. This embodiment includes a QWERTY software module that allows the operator to use the second touch screen 620 as a full qwerty keyboard. The software also allows the second touch screen 620 toggle back and forth between halves of a full qwerty keyboard. A soft key 630 can be used to control the software module.

FIG. 6(b) shows the alternate embodiment 600 with the full qwerty keyboard displayed in the second touch screen 620. The present QWERTY software module expands on the capabilities of a touch screen. Each key in a full qwerty keyboard is made available to the user on the front the device. The keyboard and predictive text software make texting a joy to the user of the present device. The QWERTY software module can provide multiple languages and the software can be applied to other phones, PDA and laptops.

FIG. 6(c) shows the alternate embodiment 600 with the first half of a qwerty keyboard displayed in the bottom portion 610 of the device. When texting, the operator can use soft key 630 to toggle back and forth between the left and right halves of a full qwerty keyboard.

FIG. 6(d) shows the alternate embodiment 600 with the second half of a qwerty keyboard on the second touch screen 620.

The foregoing description of the specific embodiments will so fully reveal the general nature of the invention that others can, by applying current knowledge, readily modify and/or adapt for various applications such specific embodiments without departing from the generic concept. For example, a stand alone MP3/Game Player model could be provided with music controls on one side and game player controls on the back. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A personal electronic device that can be used as a telephone, a video and music player, and as a video game player with real video game control buttons, the device being capable of operating in a telephone mode, a digital music and video mode, and in a video game player mode, the device comprising:
a first touch screen that displays telephone data when the device is in the telephone mode, music and video information when the device is in the digital music and video mode, and video game animation when the device is in the video game player mode;
a second touch screen that displays telephone keypad data when the device is in the telephone mode, and music player control buttons when the device is in the digital music and video mode;
wherein the first touch screen located on a front of the device, in a top half of the device, and the second touch screen is located on the front of the device, in a bottom half of the device, and when both touch screens are facing a user, the device is in a first position.

2. The device of claim 1, wherein the bottom half of the device further comprises a back, and a first set of gaming control buttons are provided on the back of the bottom half, and further wherein the bottom half the device is rotate-able, relative to the top half of the device, so that when the bottom half is rotated 180 degrees the device enters a second position, wherein the gaming control buttons are presented to the user.

3. The device of claim 1, wherein the device is further capable of operating in a texting mode, wherein the second touch screen displays a full qwerty keyboard and the user is able to input text information via the second touch screen, and further wherein the device is able to display the keyboard in multiple languages.

4. The device of claim 2, wherein the top half of the device further comprises a back, and the back is able to slide, relative to the front of the top half of the device, upward past a top of the device, so that an extension of the device is provided above the first touch screen, the extension exposing a second set of gaming control buttons for use by the user.

5. The device of claim 4, wherein the extension of the device is able to move into a position that is flush and level with the first touch screen.

6. The device of claim 3, wherein the second touch screen is able to toggle back and forth between a left half and a right half of a qwerty keyboard, when the device is in the texting mode.

7. The device of claim 1, wherein the device further comprises wireless data transmission applications that are compatible with SIM Application Toolkit, Wireless Application Protocol (WAP), Bluetooth, Wi-Fi/Wi-Max and a TV tuner.

8. The device of claim 1, further comprising a digital camera, the digital camera being able to capture still and moving pictures that can be displayed on the first touch screen.

9. The device of claim 1, wherein the telephone data displayed by the first touch screen includes outgoing call information, incoming call information, address book information, remaining battery power, antenna signal strength, texting information and Internet browser information.

10. The device of claim 1, wherein the telephone keypad data displayed by the second touch screen includes numbers, letters and symbols.

11. A personal electronic device that can be used as a telephone, a video and music player, and as a text messaging apparatus with full qwerty keyboard, the device being capable of operating in a telephone mode, a digital music and video mode, and in a texting mode, the device comprising:
a first touch screen that displays telephone data when the device is in the telephone mode, music and video information when the device is in the digital music and video mode, and texting information when the device is in the texting mode;
a second touch screen that displays telephone keypad data when the device is in the telephone mode, and music player control buttons when the device is in the digital music and video mode;
wherein the first touch screen located on a front of the device, in a top half of the device, and the second touch screen is located on the front of the device, in a bottom half of the device, and when both touch screens are facing a user, the device is in a first position.

12. The device of claim 11, wherein the bottom half of the device further comprises a back, and a first half of the full qwerty keyboard is are provided on the back of the bottom half, and further wherein the bottom half the device is rotate-able, relative to the top half of the device, so that when the bottom half is rotated 180 degrees the device enters a second position, wherein the first half of the full qwerty keyboard is presented to the user.

13. The device of claim 12, wherein the second touch screen displays a full qwerty keyboard and the user is able to input text information via the second touch screen when the device is in the texting mode, and further wherein the device is able to display the keyboard in different languages.

14. The device of claim 12, wherein the top half of the device further comprises a back, and the back is able to slide, relative to the front of the top half of the device, upward past a top of the device, so that an extension of the device is provided, the extension exposing a second half of the full qwerty keyboard above the first touch screen for use by the user.

15. The device of claim 14, wherein the extension of the device is able to move into a position that is flush and level with the first touch screen.

16. The device of claim 11, wherein the second touch screen is able to toggle back and forth between a left half and a right half of a qwerty keyboard, when the device is in the texting mode.

17. The device of claim 11, wherein the device further comprises wireless data transmission applications that are compatible with SIM Application Toolkit, Wireless Application Protocol (WAP), Bluetooth, Wi-Fi/Wi-Max and a TV tuner.

18. The device of claim 11, wherein the device includes applications for using Short Message Service (SMS), Multi-media Messaging Service (MMS), Instant Messaging (IM), e-mail, and predictive text software.

19. The device of claim 11, wherein the telephone data displayed by the first touch screen includes outgoing call information, incoming call information, address book information, remaining battery power, antenna signal strength, texting information and Internet browser information.

20. The device of claim 11, wherein the telephone keypad data displayed by the second touch screen includes numbers, letters and symbols.
